(19) United States
(12) Patent Application Publication
(10) Pub. No.: US 2025/0085171 A1
(43) Pub. Date: Mar. 13, 2025

(54) APPARATUS FOR MEASURING BATTERY CELL TEMPERATURE AND METHOD THEREOF

(71) Applicants: HYUNDAI MOTOR COMPANY, SEOUL (KR); KIA CORPORATION, SEOUL (KR)

(72) Inventors: Yo Han Baek, Anyang-si (KR); Yoo Hong Jang, Suwon-si (KR)

(21) Appl. No.: 18/430,126

(22) Filed: Feb. 1, 2024

(30) Foreign Application Priority Data
Sep. 13, 2023 (KR) 10-2023-0122059

(51) Int. Cl. G01K 3/00; G01K 1/02; G01K 1/024; G01K 7/16; H01M 10/42; H01M 10/48

(52) U.S. Cl. CPC G01K 3/005; G01K 1/024; G01K 1/026; G01K 7/16; H01M 10/425; H01M 2010/4271; H01M 10/486

(57) ABSTRACT

An apparatus for measuring a battery cell temperature includes a memory that stores a program instruction, a processor that executes the program instruction, and a plurality of first temperature sensors that detects whether temperatures of all or some of a plurality of battery cells exceed a threshold temperature. The first temperature sensor may correspond to an individual battery cell included in all or some of the plurality of battery cells in an N:1 relationship, where N may be a natural number greater than or equal to 1 and represent a number of the first temperature sensor, and 1 represents a number of individual batteries. The processor may collect data related to the temperatures of all or some of the plurality of battery cells based on detecting whether a temperature of the individual battery cell exceeds the threshold temperature through at least one of the plurality of first temperature sensors.

### CROSS REFERENCE TO RELATED APPLICATIONS

This application claims the benefit of priority to Korean Patent Application No. 10-2023-0122059, filed in the Korean Intellectual Property Office on Sep. 13, 2023, the entire contents of which are incorporated herein by reference.

### TECHNICAL FIELD

The present disclosure relates to an apparatus for measuring a battery cell temperature and a method thereof, and more specifically, to a technology for detecting whether the temperature of a battery cell exceeds a threshold temperature through a temperature sensor.

### BACKGROUND

Thermal runaway phenomenon occurring in lithium-ion batteries used in an energy storage system (ESS) or an electric vehicle (EV) has not yet been solved. Various countermeasures have been sought, such as preventing thermal runaway phenomenon or securing evacuation time by detecting thermal runaway phenomenon before fire or explosion caused by thermal runaway occurs.

Thermal runaway phenomenon is a phenomenon in which, as the temperature of a battery rises, the internal elements of a battery cell (separator, electrolyte, anode, cathode, and the like) are decomposed, melted, vaporized, or short-circuited, resulting in a chain reaction of abnormal heat generation. Such thermal runaway phenomenon may cause heat generation starting from one cell to transfer to surrounding cells, thereby causing serial heat generation, ignition, or explosion.

One of the representative precursor symptoms of thermal runaway phenomenon is an abnormal temperature rise. A battery management system (BMS) monitors the temperature of a battery cell through a temperature sensor to restrict the battery to be used when the temperature of the battery cell becomes excessively high.

There are required a temperature sensor and an analog-to-digital converter (ADC) circuit to monitor the temperature of a battery cell. In addition, to detect the temperatures of all cells, temperature sensors and ADC circuits proportional to the number of battery cells are required, which increases cost (materials, volume).

Due to high cost, it is common to measure the temperatures of only a few to dozens of cells among hundreds of battery cells in a battery pack and not measure the temperatures of the remaining cells. Accordingly, there is a limit (temperature measurement blind spot) in which the temperature of a battery cell to which a sensor is not attached cannot be measured.

When heat generation higher than a threshold temperature occurs in a battery cell located in the temperature measurement blind spot, the BMS may not immediately recognize the heat generation. The BMS may detect heat through a temperature sensor only when the temperature of a corresponding battery cell rises as the abnormal heat of the battery cell located in the temperature measurement blind spot is transferred to the surrounding battery cells to which temperature sensors are attached.

As described above, when the BMS detects the precursor symptoms of thermal runaway only after the heat generated from a battery cell where thermal runaway first occurred increases the temperature of the battery cell to which the temperature sensor is attached, it is difficult to secure sufficient time for the user to evacuate.

### SUMMARY

The present disclosure has been made to solve the above-mentioned problems occurring in the prior art while advantages achieved by the prior art are maintained intact.

An aspect of the present disclosure provides an apparatus for measuring a battery cell temperature and a method thereof capable of minimizing blind spots where the temperature of a battery cell is not measured.

Another aspect of the present disclosure provides an apparatus for measuring a battery cell temperature and a method thereof capable of measuring the temperatures of many battery cells with a minimum number of channels by connecting a plurality of temperature sensors to a processor through one channel.

Still another aspect of the present disclosure provides an apparatus for measuring a battery cell temperature and a method thereof capable of reducing component cost by measuring the temperature of many battery cells using only a minimum number of channels.

Still another aspect of the present disclosure provides an apparatus for measuring a battery cell temperature and a method thereof capable of quickly detecting whether a battery cell is abnormal by diagnosing the battery cell only based on whether the temperature of the battery cell exceeds a threshold temperature.

Still another aspect of the present disclosure provides an apparatus for measuring a battery cell temperature and a method thereof capable of securing a user's evacuation time by quickly detecting an abnormality in a battery cell.

Still another aspect of the present disclosure provides an apparatus for measuring a battery cell temperature and a method thereof capable of increasing the convenience of collecting data related to the temperature of a battery cell by using software.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for measuring a battery cell temperature includes a memory that stores a program instruction, a processor that executes the program instruction, and a plurality of first temperature sensors that detects whether temperatures of all or some of a plurality of battery cells exceed a threshold temperature, wherein the first temperature sensor may correspond to an individual battery cell included in all or some of the plurality of battery cells in an N:1 relationship, wherein N may be a natural number greater than or equal to 1 and represent a number of the first temperature sensor, and 1 represents a number of individual batteries, and wherein the processor may collect data related to the temperatures of all or some of the plurality of battery cells based on detecting whether a temperature of the individual battery cell exceeds the threshold temperature through at least one of the plurality of first temperature sensors.

According to an embodiment, the processor may detect whether the temperature of the individual battery cell exceeds the threshold temperature through one channel to which the plurality of first temperature sensors are connected.

According to an embodiment, the first temperature sensor may include a temperature switch whose resistance value changes based on identifying whether the temperature of the individual battery cell exceeds the threshold temperature.

According to an embodiment, the threshold temperature may include a first threshold temperature at which durability of the individual battery cell is reduced.

According to an embodiment, the data related to the temperatures may include at least one of a time for which the temperature of the individual battery cell is maintained above the threshold temperature, a number of times the temperature of the individual battery cell exceeds the threshold temperature, durability of the individual battery cell, durability of a battery management system including the plurality of battery cells, or a time for which the temperature of the individual battery cell is maintained at a temperature that does not exceed the threshold temperature after exceeding the threshold temperature, or a combination thereof.

According to an embodiment, the processor may upload the data related to the temperatures of all or some of the plurality of battery cells to at least one of a battery management system, or a server, or a combination thereof, or store the data related to the temperatures of all or some of the plurality of battery cells in the memory, based on identifying that the temperature of the individual battery cell exceeds the threshold temperature.

According to an embodiment, the threshold temperature may include a second threshold temperature at which a risk of fire occurs in the individual battery cell before fire or explosion occurs due to thermal runaway, and the processor may provide a warning to a user for emergency evacuation based on identifying that the temperature of the individual battery cell exceeds the second threshold temperature.

According to an embodiment, the apparatus may further include a plurality of second temperature sensors, wherein the first temperature sensor may detect whether the temperature of the individual battery cell exceeds a first threshold temperature at which durability of the individual battery cell is reduced, the second temperature sensor may detect whether the temperature of the individual battery cell exceeds a second threshold temperature at which a risk of fire occurs in the individual battery cell before fire or explosion occurs due to thermal runaway, and the processor may collect the data related to the temperatures of all or some of the plurality of battery cells based on detecting that the temperature of the individual battery cell exceeds the first threshold temperature, the second threshold temperature or a combination thereof through at least one first temperature sensor among the plurality of first temperature sensors and at least one second temperature sensor among the plurality of second temperature sensors.

According to an embodiment, the processor may determine that the data related to the temperatures of all or some of the plurality of battery cells is abnormal, based on identifying that the temperature of the individual battery cell does not exceed the first threshold temperature and the temperature of the individual battery cell exceeds the second threshold temperature.

According to an embodiment, the apparatus may further include a plurality of third temperature sensors, wherein the third temperature sensor may detect whether the temperature of the individual battery cell exceeds a third threshold temperature between the first threshold temperature and the second threshold temperature, and wherein the processor may provide a warning for emergency evacuation to a user by reflecting changes in the temperature of the individual battery cells based on identifying that the temperature of the individual battery cell exceeds the second threshold temperature through the second temperature sensor after it is identified the temperature of the individual battery cell exceeds the first threshold temperature through the first temperature sensor and the temperature of the individual battery cell exceeds the third threshold temperature through the third temperature sensor.

According to another aspect of the present disclosure, a method of measuring a battery cell temperature includes detecting, by at least one of a plurality of first temperature sensors, whether a temperature of an individual battery cell included in all or some of a plurality of battery cells exceed a threshold temperature, and collecting, by a processor, data related to the temperatures of all or some of the plurality of battery cells based on detecting whether the temperature of the individual battery cell exceeds the threshold temperature through at least one of the plurality of first temperature sensors.

According to an embodiment, the collecting of the data may include detecting, by the processor, whether the temperature of the individual battery cell exceeds the threshold temperature through one channel to which the plurality of first temperature sensors are connected.

According to an embodiment, the first temperature sensor may include a temperature switch whose resistance value changes based on identifying whether the temperature of the individual battery cell exceeds the threshold temperature.

According to an embodiment, the threshold temperature may include a first threshold temperature at which durability of the individual battery cell is reduced.

According to an embodiment, the data related to the temperatures may include at least one of a time for which the temperature of the individual battery cell is maintained above the threshold temperature, a number of times the temperature of the individual battery cell exceeds the threshold temperature, durability of the individual battery cell, durability of a battery management system including the plurality of battery cells, or a time for which the temperature of the individual battery cell is maintained at a temperature that does not exceed the threshold temperature after exceeding the threshold temperature, or a combination thereof.

According to an embodiment, the method may further include uploading, by the processor, the data related to the temperatures of all or some of the plurality of battery cells to at least one of a battery management system, or a server, or a combination thereof, or storing the data related to the temperatures of all or some of the plurality of battery cells in the memory, based on identifying that the temperature of the individual battery cell exceeds the threshold temperature.

According to an embodiment, the threshold temperature may include a second threshold temperature at which a risk of fire occurs in the individual battery cell before fire or explosion occurs due to thermal runaway, and the method may further include providing, by the processor, a warning to a user for emergency evacuation based on identifying that the temperature of the individual battery cell exceeds the second threshold temperature.

According to an embodiment, the detecting of whether the temperature of the individual battery cell exceeds the threshold temperature may include detecting, by the first temperature sensor, whether the temperature of the individual battery cell exceeds a first threshold temperature at which durability of the individual battery cell is reduced, and detecting, by a second temperature sensor, whether the temperature of the individual battery cell exceeds a second threshold temperature at which a risk of fire occurs in the individual battery cell before fire or explosion occurs due to thermal runaway, wherein the collecting of the data may include collecting, by the processor, the data related to the temperatures of all or some of the plurality of battery cells based on detecting that the temperature of the individual battery cell exceeds the first threshold temperature, the second threshold temperature or a combination thereof through at least one first temperature sensor among the plurality of first temperature sensors and at least one second temperature sensor among the plurality of second temperature sensors.

According to an embodiment, the collecting of the data may include determining, by the processor, that the data related to the temperatures of all or some of the plurality of battery cells is abnormal based on identifying that the temperature of the individual battery cell does not exceed the first threshold temperature and the temperature of the individual battery cell exceeds the second threshold temperature.

According to an embodiment, the detecting of whether the temperature of the individual battery cell exceeds the threshold temperature may include detecting, by a third temperature sensor, whether the temperature of the individual battery cell exceeds a third threshold temperature between the first threshold temperature and the second threshold temperature, and wherein the method further includes providing, by the processor, a warning for emergency evacuation to a user by reflecting changes in the temperature of the individual battery cells based on identifying that the temperature of the individual battery cell exceeds the second threshold temperature through the second temperature sensor after it is identified the temperature of the individual battery cell exceeds the first threshold temperature through the first temperature sensor and the temperature of the individual battery cell exceeds the third threshold temperature through the third temperature sensor.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating the configuration of an apparatus for measuring a battery cell temperature according to an embodiment of the present disclosure;

FIG. 2 is a diagram illustrating an example of a situation in which a temperature sensor is required for each battery cell that generates heat in an apparatus for measuring a battery cell temperature according to an embodiment of the present disclosure;

FIG. 3 is a diagram illustrating a battery management system including only a temperature sensor and an ADC channel capable of measuring the temperature of a battery cell in an apparatus for measuring a battery cell temperature according to an embodiment of the present disclosure;

FIG. 4 is a diagram illustrating a battery management system including a temperature sensor and a DI channel that determines whether the temperature of the battery cell exceeds a threshold temperature in an apparatus for measuring a battery cell temperature according to an embodiment of the present disclosure;

FIG. 5 is a circuit diagram illustrating the operation of a temperature switch when the temperature of the battery cell of an apparatus for measuring a battery cell temperature according to an embodiment of the present disclosure exceeds a threshold temperature;

FIG. 6A is a diagram illustrating a battery management system that includes a first temperature sensor that determines whether the temperature of a battery cell of an apparatus for measuring a battery cell temperature according to an embodiment of the present disclosure exceeds a first threshold temperature and a DI channel;

FIG. 6B is a diagram illustrating a battery management system that includes a second temperature sensor that determines whether the temperature of a battery cell of an apparatus for measuring a battery cell temperature according to an embodiment of the present disclosure exceeds a second threshold temperature and a DI channel;

FIG. 6C is a diagram illustrating a battery management system that includes a first temperature sensor, a second temperature sensor and a DI channel that determine whether the temperature of a battery cell of an apparatus for measuring a battery cell temperature according to an embodiment of the present disclosure exceeds a first threshold temperature or a second threshold temperature and a DI channel;

FIG. 7 is a flowchart illustrating a method of measuring a battery cell temperature according to an embodiment of the present disclosure;

FIG. 8 is a flowchart illustrating a method of uploading data related to the temperature of a battery cell based on whether the temperature of the battery cell exceeds the first threshold temperature in a method of measuring a battery cell temperature according to an embodiment of the present disclosure;

FIG. 9 is a flowchart illustrating a method of uploading data related to the temperature of a battery cell based on whether the temperature of the battery cell exceeds the second threshold temperature in a method of measuring a battery cell temperature according to an embodiment of the present disclosure;

FIG. 10 is a flowchart illustrating a method of uploading data related to the temperature of a battery cell based on whether the temperature of the battery cell exceeds the first threshold temperature and the second threshold temperature in a method of measuring a battery cell temperature according to an embodiment of the present disclosure; and

FIG. 11 is a block diagram illustrating a computing system related to an apparatus for measuring a battery cell temperature and a method of measuring a battery cell temperature according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. In addition, a phrase such as “at least one of A, B, C, or any combination thereof” may include “A or B or C or a combination thereof such as AB, BC, AC, or ABC”.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

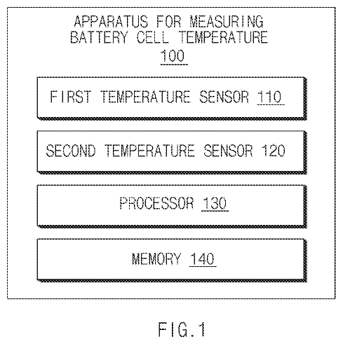

Hereinafter, embodiments of the present disclosure will be described in detail with reference to FIGS. 1 to 11.

FIG. 1 is a block diagram illustrating the configuration of an apparatus for measuring a battery cell temperature according to an embodiment of the present disclosure.

According to an embodiment, an apparatus 100 for measuring a battery cell temperature may include a first temperature sensor 110, a second temperature sensor 120, a processor 130, and a memory 140. The configuration of the apparatus 100 for measuring a battery cell temperature shown in FIG. 1 is illustrative, and embodiments of the present disclosure are not limited thereto. For example, the apparatus 100 for measuring a battery cell temperature may further include components not shown in FIG. 1.

According to an embodiment, the memory 140 may store commands or data. For example, the memory 140 may store one instruction or two or more instructions that, when executed by the processor 130, allow the apparatus 100 for measuring a battery cell temperature to perform various operations.

According to an embodiment, the memory 140 may be implemented as a single chipset with the processor 130, and may store various information related to the apparatus 100 for measuring a battery cell temperature. For example, the memory 140 may store data related to the temperature of a battery cell.

According to an embodiment, the memory 140 may include a non-volatile memory (e.g., a read only memory: ROM) and a volatile memory (e.g., a random access memory: RAM).

According to an embodiment, the battery of a vehicle may include a battery cell, a module, and a pack. As a specific example, a plurality of battery cells may be combined to form a battery module, and a plurality of battery modules may be combined to form a battery pack.

According to an embodiment, a battery cell may include a lithium-ion battery that may be used by charging and discharging electrical energy. In detail, the battery cell may be configured to include at least one of an anode, a cathode, a separator, or an electrolyte, or any combination thereof in an aluminum case.

According to an embodiment, a battery module may be configured such that a certain number of battery cells are bundled together and included in a frame of the battery module to protect against external shock, heat, or vibration.

According to an embodiment, a battery pack may be the final form of a battery system mounted on a vehicle, and include various control and protection systems such as a battery management system (BMS), a cooling system and the like linked to the battery module.

According to an embodiment, the first temperature sensor 110 may detect whether the temperature of all or some of battery cells exceeds a threshold temperature. For example, the plurality of first temperature sensors 110 may detect whether the temperature of all or some of the plurality of battery cells exceeds the threshold temperature.

According to an embodiment, the plurality of battery cells may include a set of individual battery cells.

According to an embodiment, the threshold temperature may be set to a temperature at which the durability of a battery cell is reduced or a temperature at which there is a risk of fire occurring in a battery cell before fire or explosion occurs due to thermal runaway.

According to an embodiment, the threshold temperature may include a first threshold temperature at which the durability of an individual battery cell is reduced, or a second threshold temperature at which there is a risk of fire occurring in an individual battery cell before fire or explosion occurs due to thermal runaway.

For example, the first threshold temperature at which the durability of a battery cell is reduced may be set to 65 degrees, at which the battery cell may show a sign of abnormality.

For example, before a fire or explosion due to thermal runaway occurs, the second threshold temperature at which there is a risk of fire in a battery cell may be set to 100 degrees, at which the battery cell may ignite.

As another example, the second threshold temperature at which there is a risk of fire in a battery cell may be set to 100 degrees, at which off-gas may be produced from the battery cell.

According to an embodiment, the first temperature sensor 110 may identify whether the temperature of an individual battery cell exceeds the threshold temperature. For example, when the threshold temperature of the first temperature sensor 110 is set to 65 degrees and the temperature of an individual battery cell exceeds 65 degrees, it may be identified that the temperature of an individual battery cell exceeds the threshold temperature.

According to an embodiment, the first temperature sensor 110 may include a temperature switch whose resistance value changes based on identifying whether the temperature of the individual battery cell exceeds the threshold temperature. For example, when the temperature of the battery cell does not exceed the threshold temperature, the temperature switch may maintain a low resistance value. To the contrary, when the temperature of the battery cell exceeds the threshold temperature, the temperature switch may maintain a high resistance value.

According to an embodiment, the first temperature sensor 110 may include a temperature switch that switches the switch circuit to a shorted state or an open state based on identifying whether the temperature of the individual battery cell exceeds the threshold temperature. For example, when the temperature of the battery cell does not exceed the threshold temperature, the temperature switch may convert the switch circuit to a short circuit. To the contrary, when the temperature of the battery cell exceeds the threshold temperature, the temperature switch may convert the switch circuit to an open circuit.

According to an embodiment, the first temperature sensor 110 may include a positive temperature coefficient thermistor (PTC) temperature switch or a bimetal temperature switch.

According to an embodiment, the first temperature sensor 110 may correspond to an individual battery cell included in all or some of the plurality of battery cells in an N:1 relationship. In this case, ‘N’ is a natural number greater than or equal to ‘1’ representing the number of first temperature sensors, and ‘1’ may represent the number of individual batteries.

For example, one first temperature sensor 110 may correspond to each individual battery cell. That is, one first temperature sensor 110 may be configured to identify whether the temperature of one individual battery cell exceeds the threshold temperature.

As still another example, two or more first temperature sensors 110 may correspond to each individual battery cell. In this case, two or more first temperature sensors 110 may measure temperatures at different locations of one individual battery cell.

According to an embodiment, the processor 130 may collect data related to the temperatures of all or some of the plurality of battery cells based on detecting whether the temperature of an individual battery cell exceeds the threshold temperature through at least one of the plurality of first temperature sensors 110.

According to an embodiment, the data related to the temperatures of all or some of the plurality of battery cells may include at least one of a time for which the temperature of the individual battery cell is maintained above the threshold temperature, the number of times the temperature of the individual battery cell exceeds the threshold temperature, the durability of the individual battery cell, the durability of a battery management system including the plurality of battery cells, or a time for which the temperature of the individual battery cell is maintained at a temperature that does not exceed the threshold temperature after exceeding the threshold temperature, or a combination thereof.

For example, the processor 130 may measure the time in units of second for which the temperature of an individual battery cell is maintained above the threshold temperature. In this case, the unit of time for measuring the temperature of an individual battery cell may vary depending on the threshold temperature.

For example, when the time for which the temperature of an individual battery cell remains above the threshold temperature exceeds a preset time, the processor 130 may collect the corresponding time as data. In this case, the preset time may be set differently depending on the threshold temperature. In detail, the higher the threshold temperature, the longer the time preset by data may be set.

For example, the processor 130 may calculate the number of times the temperature of an individual battery cell exceeds the threshold temperature and collect it as data. For example, the processor 130 may increase the number of times the temperature of an individual battery cell exceeds the threshold temperature every time the temperature of the individual battery cell exceeds the threshold temperature. In addition, when the temperature of an individual battery cell exceeds the threshold temperature, the number of times the temperature of the individual battery cell exceeds the threshold temperature is increased by ‘1’. When the temperature of the individual battery cell decreases to a temperature that does not exceed the threshold temperature and then increases again to a temperature that exceeds the threshold temperature, the number of times the threshold temperature has been exceeded may be further increased by 1.

For example, the processor 130 may collect data related to the durability of an individual battery cell or the durability of a battery management system including the plurality of battery cells. When the temperature of the battery cell exceeds a temperature that may affect the durability of the battery cell, the vaporization of electrolyte may occur, thereby reducing the durability of the battery cell. The processor 130 may collect data that may be used to determine the durability of all or some of the battery cells through the temperature of an individual battery cell.

For example, when the temperature of an individual battery cell exceeds the threshold temperature and then decreases to a temperature that does not exceed the threshold temperature, the processor 130 may collect data on a time for which the temperature of the individual battery cell is maintained at a temperature that does not exceed the threshold temperature. Such data may include information about how the temperature of the battery cell decreases after exceeding the threshold temperature, and then increases again to a temperature exceeding the threshold temperature after some time. In this case, the time for which the temperature of an individual battery cell is maintained at a temperature that does not exceed the threshold temperature may be measured in units of second.

According to an embodiment, based on identifying that the temperature of the individual battery cell exceeds the threshold temperature, the processor 130 may upload the data related to the temperatures of all or some of the plurality of battery cells to at least one of a battery management system, or a server, or a combination thereof, or store the data related to the temperatures of all or some of the plurality of battery cells in the memory 140. In this case, when transmitting data, a controller area network (CAN) or a wireless communication device within the vehicle may be used.

For example, the processor 130 may upload time-related data among data related to the temperatures of all or some of the battery cells as data in units of second to at least one of a battery management system, or a server, or a combination thereof, or store the time-related data in the memory 140.

As still another example, the processor 130 may convert the time-related data among the data related to the temperatures of all or some of the battery cells into data in units of minute and upload the time-related data to at least one of a management system, or a server, or a combination thereof, or store the time-related data in the memory 140. In this case, the data in units of minute is smaller than data in units of second, so that data transmission time and data capacity may be reduced.

According to an embodiment, the processor 130 may include at least one of an analog-to-digital converter (ADC) circuit, a digital input (DI) circuit, or an analog input (AI) circuit, or a combination thereof. For example, the processor 130 may include a programmable logic controller (PLC) circuit. In addition, the processor 130 may include a micro controller unit (MCU).

According to an embodiment, the ADC circuit may convert an input signal (analog signal or discrete signal) into a digital signal with a resolution of 2 bits or more and transmit it to the processor 130.

According to an embodiment, the DI circuit may convert an input signal (discrete signal) into a 1-bit resolution digital signal and transmit it to the processor 130.

According to an embodiment, the processor 130 may include a plurality of channels through which signals related to input or output can be transmitted. In this case, the channel may serve to connect input/output devices such as temperature sensors and temperature switches, an ADC circuit, and a DI circuit. For example, an ADC channel may refer to a channel connected to the ADC circuit, and a DI channel may refer to a channel connected to the DI circuit.

According to an embodiment, the processor 130 may detect whether the temperature of an individual battery cell exceeds the threshold temperature through one channel to which the plurality of first temperature sensors 110 are connected.

For example, when the first temperature sensor 110 corresponds to a temperature switch that corresponds 1:1 to each individual battery cell, a plurality of temperature switches may be connected to one DI channel. In this case, when one of the temperature switches detects that the temperature of an individual battery cell exceeds the threshold temperature, the processor 130 may determine that the battery cell is abnormal. As a specific example, when even one of 100 first temperature sensors 110 corresponding to 100 individual battery cells detects that the temperature of an individual battery cell exceeds the threshold temperature, the processor 130 may determine that the battery cell is abnormal.

As another example, when any one of the plurality of temperature switches detects that the temperature of an individual battery cell exceeds the threshold temperature, the resistance value of the temperature switch corresponding to the battery cell exceeding the threshold temperature may increase or the circuit of the temperature switch may be switched to be in an open state. As the voltage applied to the DI channel changes due to this, the processor 130 may determine whether the battery cell is abnormal. As a specific example, when even one first temperature sensor 110 among 100 first temperature sensors 110 corresponding to 100 individual battery cells is converted to be in an open state, the processor 130 may detect that the battery cell is abnormal.

According to an embodiment, the processor 130 may provide a warning for emergency evacuation to the user based on identifying that the temperature of an individual battery cell exceeds a second threshold temperature. In this case, the second threshold temperature may be a temperature at which there is a risk of fire occurring in the individual battery cell before fire or explosion due to thermal runaway occurs.

For example, when the second threshold temperature is set to 100 degrees and it is identified that the temperature of an individual battery cell exceeds 100 degrees through the first temperature sensor 110, the processor 130 may provide a warning for emergency evacuation to the user. In detail, the processor 130 may provide the warning for emergency evacuation to the user through at least one of an in-vehicle display, in-vehicle audio, or a user terminal, or a combination thereof.

According to an embodiment, the first temperature sensor 110 may detect whether the temperature of the individual battery cell exceeds the first threshold temperature at which the durability of the individual battery cell is reduced, and the second temperature sensor 120 may detect whether the temperature of the individual battery cell exceeds the second threshold temperature at which a risk of fire occurs in the individual battery cell before fire or explosion occurs due to thermal runaway.

In addition, the processor 130 may collect the data related to the temperatures of all or some of the plurality of battery cells based on detecting that the temperature of the individual battery cell exceeds the first threshold temperature, the second threshold temperature or a combination thereof through at least one of the plurality of first temperature sensors 110 and at least one of the plurality of second temperature sensors 120.

For example, the processor 130 may detect whether the temperature of an individual battery cell exceeds the first threshold temperature through the first temperature sensor 110. In addition, the processor 130 may detect whether the temperature of an individual battery cell exceeds the second threshold temperature through the second temperature sensor 120.

For example, when the temperature of an individual battery cell exceeds the first threshold temperature through the first temperature sensor 110, the processor 130 may collect data related to the first threshold temperature. In addition, when the temperature of an individual battery cell exceeds the second threshold temperature through the second temperature sensor 120, the processor 130 may collect the data related to the second threshold temperature and further provide a warning for emergency evacuation to the user.

According to an embodiment, the individual battery cell whose temperature is detected to exceed the first threshold temperature through the first temperature sensor 110 and the individual battery cell whose temperature is detected to exceed the second threshold temperature through the second temperature sensor 120 may be the same. In this case, the processor 130 may identify whether the temperature of an individual battery cell exceeds the first threshold temperature and then exceeds the second threshold temperature.

According to an embodiment, the processor 130 may determine that the data related to the temperatures of all or some of the plurality of battery cells is abnormal, based on identifying that the temperature of the individual battery cell does not exceed the first threshold temperature and the temperature of the individual battery cell exceeds the second threshold temperature.

For example, in the case where the first threshold temperature is set to 65 degrees and the second threshold temperature is set to 100 degrees, when it is identified that the temperature of the individual battery cell exceeds only the second threshold temperature even though the temperature of the individual battery cell increases from 20 degrees, it may fail to identify that the temperature of the individual battery cell exceeds the first threshold temperature of 65 degrees even though the temperature of the individual battery cell exceeds the first threshold temperature. In this case, the processor 130 may determine that there is an abnormality in the data collected related to the temperatures of the individual battery cells.

According to an embodiment, the apparatus 100 for measuring a battery cell temperature may further include a plurality of third temperature sensors. In this case, the third temperature sensor may detect whether the temperature of an individual battery cell exceeds a third threshold temperature between the first threshold temperature and the second threshold temperature.

For example, when the first threshold temperature is set to 65 degrees and the second threshold temperature is set to 100 degrees, the third threshold temperature may be set to 80 degrees.

According to an embodiment, based on identifying that the temperature of the individual battery cell exceeds a second threshold temperature through the second temperature sensor 120 after it is identified the temperature of the individual battery cell exceeds the first threshold temperature through the first temperature sensor 110 and the temperature of the individual battery cell exceeds the third threshold temperature through a third temperature sensor, the processor 130 may calculate trends in temperature fluctuations of individual battery cells.

According to an embodiment, the processor 130 may reflect a change in the temperature of an individual battery cell and provide a warning for emergency evacuation to the user. For example, when the temperature of an individual battery cell sequentially exceeds the first threshold temperature, third threshold temperature, and second threshold temperature, the processor 130 may more accurately determine whether the battery cell is abnormal and provide a warning to the user to allow the user to secure sufficient time to evacuate.

According to an embodiment, the apparatus 100 for measuring a battery cell temperature may further include N temperature sensors. For example, N temperature sensors may correspond to the same battery cell or different battery cells. In addition, the N temperature sensors may include a temperature switch whose resistance value changes depending on whether the temperature of the battery cell exceeds a threshold temperature or a temperature switch whose switch circuit is converted to be in a shorted state or an open state. In this case, N temperature sensors may identify whether the temperature of the battery cell exceeds a threshold temperature based on different threshold temperatures. In addition, N temperature sensors may be connected to the processor through different channels for each threshold temperature. That is, the temperature sensor that identifies whether the temperature of the battery cell exceeds the threshold temperature based on the same threshold temperature may be connected to the processor through the same channel.

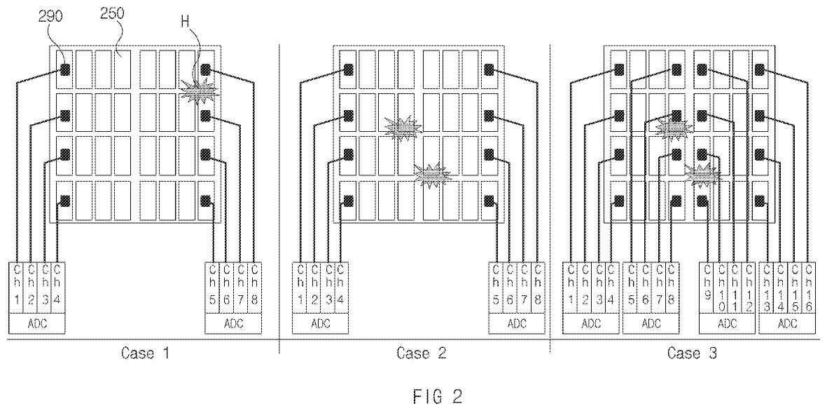

FIG. 2 is a diagram illustrating an example of a situation in which a temperature sensor is required for each battery cell that generates heat in an apparatus for measuring a battery cell temperature according to an embodiment of the present disclosure.

Referring to FIG. 2, a temperature sensor 290 according to an embodiment may be a sensor capable of measuring the temperature of a battery cell 250, and each temperature sensor 290 may be connected to one channel. In this case, the channel to which each temperature sensor 290 is connected may be a channel connected to an ADC circuit or a DI circuit depending on a type of temperature sensor.

According to an embodiment, Case 1 shows eight temperature sensors 290 corresponding to eight individual battery cells 250 among 32 battery cells. According to an embodiment, Case 1 illustrates an example in which the temperature sensor 290 is located near the battery cell 250 in which high temperature heat H is generated. In this case, the processor may detect the battery cell 250 in which the high temperature heat H is generated, through the temperature sensor 290.

According to an embodiment, Case 2 also shows eight temperature sensors 290 corresponding to eight individual battery cells 250 among 32 battery cells. According to an embodiment, Case 2 illustrates an example in which the temperature sensor 290 is not located near the battery cell 250 where high temperature heat H is generated. In this case, the processor may not detect the battery cell 250 generating high temperature heat H through the temperature sensor 290. The processor may determine whether the battery cell 250 is abnormal only when the high temperature heat H is transferred to the battery cell 250 where the temperature sensor 290 is located.

According to an embodiment, Case 3 shows 16 temperature sensors 290 corresponding to 16 individual battery cells 250 among 32 battery cells. According to an embodiment, Case 3 illustrates an example in which the temperature sensor 290 is located near the battery cell 250 where high temperature heat H is generated in Case 2. In this case, the processor may detect the battery cell 250 generating high temperature heat H through the temperature sensor 290.

According to an embodiment in FIG. 2, in order to detect high temperature heat H generated in the battery cell 250, the temperature sensor 290 must be located near the battery cell 250 in which high temperature heat H is generated. Therefore, in order to minimize the blind spot where the heat of the battery cell 250 cannot be detected, the plurality of temperature sensors 290 may be required, and accordingly, a plurality of channels which may be connected to an ADC circuit or DI circuit for each temperature sensor 290 are required.

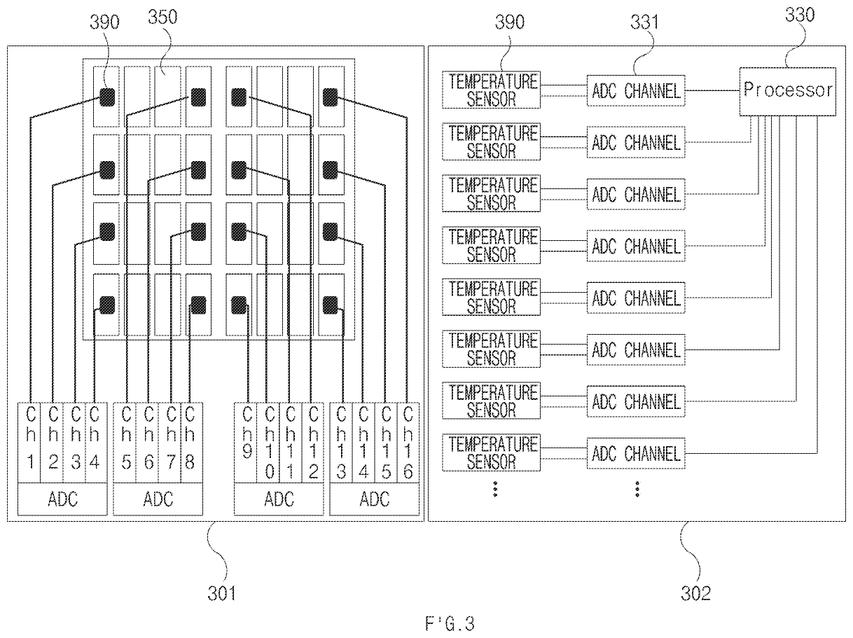

FIG. 3 is a diagram illustrating a battery management system including only a temperature sensor and an ADC channel capable of measuring the temperature of a battery cell in an apparatus for measuring a battery cell temperature according to an embodiment of the present disclosure.

Referring to FIG. 3, according to an embodiment, FIG. 3 illustrates an example 301 of a system including a channel connected to a plurality of battery cells 350, a plurality of temperature sensors 390, and a channel connected to an ADC circuit, and a block diagram 302 in which a plurality of temperature sensors 390 are connected to a processor 330 through an ADC channel 331.

Referring to FIG. 3, the temperature sensor 390 according to an embodiment, which is a sensor capable of measuring the temperature of the battery cell 350, may include a temperature sensor capable of transmitting the measured temperature as an analog signal. In this case, each temperature sensor 390 may be connected to one channel. For example, when a total of 16 temperature sensors 390 measure the temperature of the battery cell 350, a total of 16 channels may be required to be connected to each temperature sensor 390.

According to an embodiment, the channel to which each temperature sensor 390 is connected may be the ADC channel 331 connected to the ADC circuit depending on the type of temperature sensor. In addition, the temperature sensor 390 may be connected to the processor 330 through the ADC channel 331. However, this is only one embodiment, and the channel to which the temperature sensor 390 is connected may be a DI channel connected to a DI circuit depending on the type of temperature sensor.

According to an embodiment in FIG. 3, when the temperature measured by the temperature sensor 390 is transmitted as an analog signal, each temperature sensor 390 may be required to be connected to the separate ADC channel 331, so the number of ADC channels 331 corresponding to the temperature sensor 390 may be required.

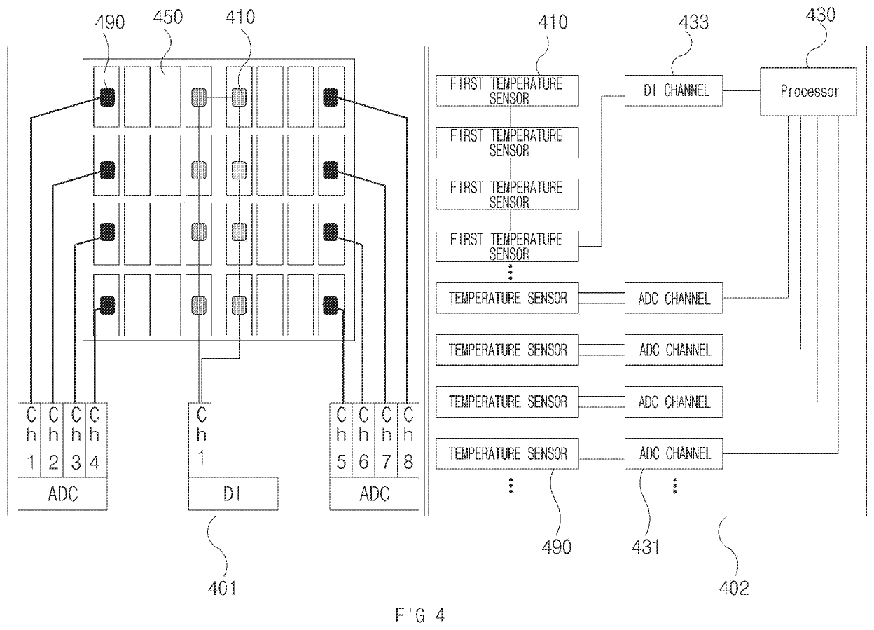

FIG. 4 is a diagram illustrating a battery management system including a temperature sensor and a DI channel that determines whether the temperature of the battery cell exceeds a threshold temperature in an apparatus for measuring a battery cell temperature according to an embodiment of the present disclosure.

Referring to FIG. 4, according to an embodiment, FIG. 4 illustrates an example 401 of a system including a plurality of battery cells 450, a plurality of temperature sensors 490, a channel connected to an ADC circuit, and a channel connected to a DI circuit, and a block diagram 402 in which a plurality of first temperature sensors 410 are connected to a processor 430 through a DI channel 433 and a plurality of temperature sensor 490 are connected to the processor 430 through an ADC channel 431.

Referring to FIG. 4, the temperature sensor 490 according to an embodiment, which is a sensor that may measure the temperature of the battery cell 450, may transmit the measured temperature as an analog signal. In this case, each temperature sensor 490 may be connected to one ADC channel.

According to an embodiment, the first temperature sensor 410 may include a temperature switch that can identify whether the temperature of the battery cell 450 exceeds a preset threshold temperature. For example, the first temperature sensor 410 may include a temperature switch whose resistance value changes depending on whether the temperature of the battery cell 450 exceeds the threshold temperature, or a temperature switch whose switch circuit is converted to be in a shorted or open state.

According to an embodiment, the plurality of first temperature sensors 410 may be connected to one DI channel 433 in series. In this case, when one of the plurality of first temperature sensors 410 identifies that the temperature of the battery cell 450 exceeds the threshold temperature, the processor 430 may determine that the battery cell 450 is abnormal through the DI channel 433.

For example, when the temperature of a specific battery cell 450 exceeds the threshold temperature, the resistance value of the first temperature sensor 410 corresponding to the battery cell 450 may change to high resistance or the switch circuit may be converted to be in an open state. Accordingly, a voltage may be applied to the DI channel 433, and the processor 430 may determine that the battery cell 450 is abnormal.

According to an embodiment in FIG. 4, unlike the temperature sensor 490 that transmits the measured temperature as an analog signal, the plurality of first temperature sensor 410, which identify whether the temperature of the battery cell 450 exceeds the threshold temperature, may be connected to one DI channel 433 in series, such that the processor 430 may determine whether the plurality of battery cells 450 are abnormal through a minimum number of channels.

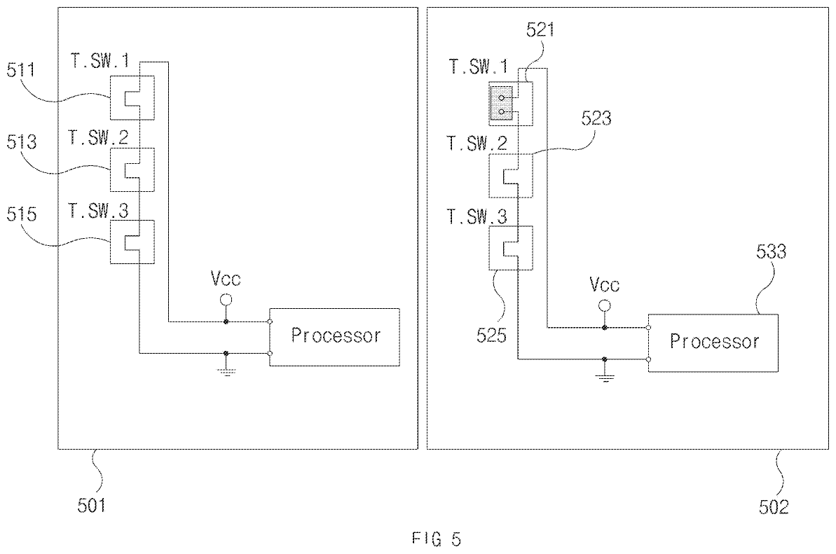

FIG. 5 is a circuit diagram illustrating the operation of a temperature switch when the temperature of the battery cell of an apparatus for measuring a battery cell temperature according to an embodiment of the present disclosure exceeds a threshold temperature.

Referring to FIG. 5, a plurality of temperature switches may be connected to a processor 533 in series. For example, first temperature switches 511 and 521, second temperature switches 513 and 523, and third temperature switches 515 and 525 may be connected to the processor 533 in series. In this case, the first temperature switches 511 and 521, the second temperature switches 513 and 523, and the third temperature switches 515 and 525 may correspond to different battery cells, respectively.

According to an embodiment, when the temperature of the battery cell does not exceed the threshold temperature in 501, the first temperature switch 511, the second temperature switch 513 and the third temperature switch 515 may be maintained to have low resistance values, or the switch circuits may be maintained in short circuit states.

For example, when the temperature of the battery cell does not exceed the threshold temperature in 501, the switch circuit of the first temperature switch 511, the second temperature switch 513 and the third temperature switch 515 connected in series may be short-circuited, so that a voltage Vcc may not be applied to the processor 533. Accordingly, the processor 533 may determine that there is no abnormality in the battery cells corresponding to the first temperature switch 511, the second temperature switch 513, and the third temperature switch 515.

According to an embodiment, when the temperature of the battery cell exceeds the threshold temperature in 502, the first temperature switch 521, the second temperature switch 523, or the third temperature switch 525 may change to have high resistance values, or the switch circuit may be converted to be in an open state.

For example, when the temperature of the battery cell corresponding to the first temperature switch 521 exceeds the threshold temperature in 502, the switch circuit of the first temperature switch 521 may be switched to an open state. In this case, the voltage Vcc may be applied to the processor to which the first temperature switch 521, the second temperature switch 523, and the third temperature switch 525 are connected in series. Accordingly, the processor 533 may determine that the battery cell corresponding to the first temperature switch 521, the second temperature switch 523, or the third temperature switch 525 is abnormal. In detail, the processor 533 may determine that high-temperature heat has occurred in the battery cell corresponding to the first temperature switch 521, the second temperature switch 523, or the third temperature switch 525.

According to an embodiment in FIG. 5, when the temperature of a battery cell corresponding to one of a plurality of temperature switches exceeds the threshold temperature, the switch circuit of the temperature switch corresponding to the battery cell may be converted to be in an open state (or high resistance), and as a voltage is applied to the processor to which a plurality of temperature switches are connected in series, the processor may determine that high-temperature heat has occurred in the corresponding battery cell.

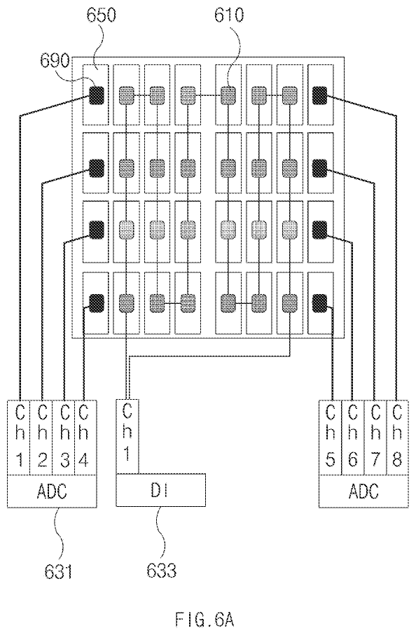

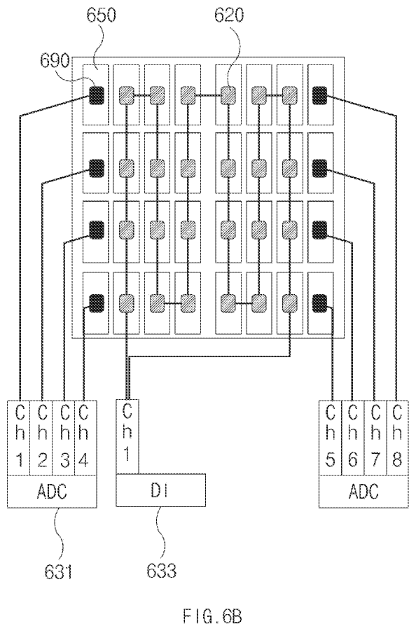

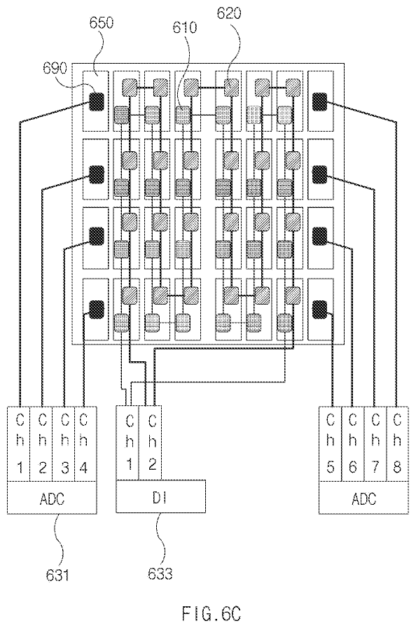

FIGS. 6A to 6C are diagrams illustrating a battery management system that determines whether the temperature of the battery cell exceeds a first threshold temperature or a second threshold temperature through a first temperature sensor or a second temperature sensor in an apparatus for measuring a battery cell temperature according to an embodiment of the present disclosure.

According to an embodiment, the battery management system may include a temperature sensor 690 that may measure the temperature of a battery cell 650 and transmit the measured temperature as an analog signal. In addition, a temperature sensor 690 may be connected to an ADC circuit 631 through a channel.

For example, when the battery management system includes the plurality of battery cells 650, one temperature sensor 690 may correspond to measure the temperature of one battery cell 650.

As a specific example, as shown in FIGS. 6A to 6C, the temperature may be measured by eight temperature sensors 690 corresponding to eight battery cells 650 among a total of 32 battery cells 650.

For example, the temperature sensor 690 may measure a change in temperature of the battery cell 650. Accordingly, the temperature value measured through each temperature sensor 690 may vary, and each temperature sensor 690 may be connected to the ADC circuit 631 through a different and separate channel. As a specific example, eight temperature sensors 690 may require eight channels to be connected to the ADC circuit 631.

FIG. 6A is a diagram illustrating a battery management system that includes a first temperature sensor that determines whether the temperature of a battery cell of an apparatus for measuring a battery cell temperature according to an embodiment of the present disclosure exceeds a first threshold temperature and a DI channel.

According to an embodiment, the battery management system may include a first temperature sensor 610 that can identify whether the temperature of the battery cell 650 exceeds a preset threshold temperature.

For example, the first temperature sensor 610 may include a temperature switch whose resistance value changes depending on whether the temperature of the battery cell 650 exceeds a threshold temperature or a temperature switch whose switch circuit changes to a short or open state.

For example, one first temperature sensor 610 may correspond 1:1 to identify whether the temperature of one battery cell 650 exceeds a threshold temperature. As a specific example, as shown in FIG. 6A, 24 first temperature sensors 610 may correspond to 24 battery cells 650 of a total of 32 battery cells 650. In this case, the plurality of first temperature sensors 610 may be connected to each other in series. In addition, the plurality of first temperature sensors 610 connected in series may be connected to a DI circuit 633 through one channel.

In this case, the threshold temperature may include a first threshold temperature at which durability of the battery cell is reduced. For example, the first threshold temperature at which the durability of the battery cell is reduced may be set to 65 degrees, at which the battery cell may show a sign of abnormality.

As a specific example, when the plurality of first temperature sensors 610 are connected in series to one channel and it is identified that the temperature of the battery cell 650 exceeds the first threshold temperature through at least one of the plurality of first temperature sensors 610, the processor may determine that high-temperature heat at which the durability of the battery cell is reduced is generated in the battery cell 650 corresponding to the plurality of first temperature sensors 610. Accordingly, the processor may identify whether the battery cell 650 is abnormal at an early stage.

According to an embodiment in FIG. 6A, when the temperature of the battery cell 650 corresponding to one of the plurality of first temperature sensors 610 exceeds the first threshold temperature, the processor may determine that high-temperature heat that may reduce the durability of the battery cell 650 is generated through one channel.

FIG. 6B is a diagram illustrating a battery management system that includes a second temperature sensor that determines whether the temperature of a battery cell of an apparatus for measuring a battery cell temperature according to an embodiment of the present disclosure exceeds a second threshold temperature and a DI channel.

According to an embodiment, the battery management system may include a second temperature sensor 620 that may identify whether the temperature of the battery cell 650 exceeds a preset threshold temperature.

For example, the second temperature sensor 620 may include a temperature switch whose resistance value changes depending on whether the temperature of the battery cell 650 exceeds a threshold temperature or a temperature switch whose switch circuit changes to a short or open state.

For example, one second temperature sensor 620 may correspond 1:1 to identify whether the temperature of one battery cell 650 exceeds the threshold temperature. As a specific example, as shown in FIG. 6B, 24 second temperature sensors 620 may correspond to 24 battery cells 650 of a total of 32 battery cells 650. In this case, the plurality of second temperature sensors 620 may be connected to each other in series. In addition, the plurality of second temperature sensors 620 connected in series may be connected to the DI circuit 633 through one channel.

In this case, the threshold temperature may include a second threshold temperature at which there is a risk of fire occurring in the battery cell before fire or explosion due to thermal runaway occurs. For example, the second threshold temperature at which there is a risk of fire occurring in a battery cell may be set to 100 degrees at which off-gas may be produced from the battery cell.

As a specific example, when the plurality of second temperature sensors 620 are connected in series to one channel and it is identified that the temperature of the battery cell 650 exceeds the second threshold temperature through at least one of the plurality of second temperature sensors 620, the processor may determine that the battery cell 650 corresponding to the plurality of second temperature sensors 620 generates high temperature heat that may cause a fire in the battery cell. Accordingly, the processor may early identify whether the battery cell 650 is at risk of explosion.

According to an embodiment in FIG. 6B, when the temperature of the battery cell 650 corresponding to one of the plurality of second temperature sensors 620 exceeds the second threshold temperature, the processor may determine that the battery cell 650 generates high temperature heat that may cause a fire in the battery cell, through one channel.

FIG. 6C is a diagram illustrating a battery management system that includes a first temperature sensor, a second temperature sensor and a DI channel that determine whether the temperature of a battery cell of an apparatus for measuring a battery cell temperature according to an embodiment of the present disclosure exceeds a first threshold temperature or a second threshold temperature and a DI channel.

According to an embodiment, the battery management system may include the first temperature sensor 610 and the second temperature sensor 620 that can identify whether the temperature of the battery cell 650 exceeds a preset threshold temperature.

For example, the first temperature sensor 610 and the second temperature sensor 620 may include a temperature switch whose resistance value changes depending on whether the temperature of the battery cell 650 exceeds a threshold temperature or a temperature switch whose switch circuit changes to a short or open state.

For example, one first temperature sensor 610 may correspond 1:1 to identify whether the temperature of one battery cell 650 exceeds a threshold temperature. In addition, one second temperature sensor 620 may also correspond 1:1 to identify whether the temperature of one battery cell 650 exceeds the threshold temperature.

For example, one first temperature sensor 610 and one second temperature sensor 620 may be matched to identify whether the temperature of the same battery cell 650 exceeds a threshold temperature. That is, both the first temperature sensor 610 and the second temperature sensor 620 may correspond to one battery cell 650. In this case, it is possible to determine whether the temperature of one battery cell 650 exceeds the first threshold temperature or the second threshold temperature through the first temperature sensor 610 and the second temperature sensor 620, respectively.

As a specific example, as shown in FIG. 6C, 24 first temperature sensors 610 and 24 second temperature sensors 620 may correspond to 24 battery cells 650 of a total of 32 battery cells 650. In this case, the plurality of first temperature sensors 610 may be connected in series to each other, and the plurality of first temperature sensors 610 connected in series may be connected to the DI circuit 633 through one channel. In addition, the plurality of second temperature sensors 620 may be connected in series to each other, and the plurality of second temperature sensors 620 connected in series may be connected to the DI circuit 633 through one channel different from the channel to which the first temperature sensor 610 is connected. That is, the first temperature sensor 610 and the second temperature sensor 620 may be connected to the DI circuit 633 through different channels.

According to an embodiment, the threshold temperature corresponding to the first temperature sensor 610 and the threshold temperature corresponding to the second temperature sensor 620 may be set to be different from each other.

For example, the threshold temperature corresponding to the first temperature sensor 610 may include a first threshold temperature at which durability of the battery cell is reduced. As a specific example, the first threshold temperature at which the durability of the battery cell is reduced may be set to 65 degrees, at which the battery cell may show a sign of abnormality.

For example, the threshold temperature corresponding to the second temperature sensor 620 may include a second threshold temperature at which there is a risk of fire occurring in the battery cell before fire or explosion due to thermal runaway occurs. As a specific example, the second threshold temperature at which there is a risk of fire in the battery cell may be set to 100 degrees, at which off-gas is generated from the battery cell.

According to an embodiment, the plurality of first temperature sensors 610 may be connected in series to channel 1 connected to the DI circuit 633, and the plurality of second temperature sensors 620 may be connected in series to channel 2 connected to the DI circuit 633. In addition, one first temperature sensor 610 and one second temperature sensor 620 may correspond to one battery cell 650.

In this case, when the temperature of the battery cell 650 increases and exceeds the first threshold temperature, it may be identified by the first temperature sensor 610. In addition, when the temperature of the battery cell 650 continues to rise and exceeds the second threshold temperature, it may be identified by the second temperature sensor 620.

According to an embodiment, when it is not identified that the temperature of the battery cell 650 exceeds the first threshold temperature and it is identified that the temperature of the battery cell 650 exceeds only the second threshold temperature, the processor may determine that the data related to the temperature of the battery cell 650 is abnormal.

For example, in the case where the first threshold temperature is set to 65 degrees and the second threshold temperature is set to 100 degrees, when it is identified that the temperature of the battery cell 650 exceeds only the second threshold temperature even though the temperature of the battery cell 650 increases from 20 degrees, the first temperature sensor 610 may fail to identify that the temperature of the battery cell 650 exceeds the first threshold temperature even though the temperature of the battery cell 650 exceeds the first threshold temperature of 65 degrees. In this case, the processor may determine that there is an abnormality in the identified result related to the temperature of the corresponding battery cell 650.

According to an embodiment according to FIG. 6C, by matching both the first temperature sensor 610 and the second temperature sensor 620 to one battery cell 650, the temperature of the battery cell 650 may be identified whether it exceeds the first threshold temperature or the second threshold temperature. In addition, when it is not identified that the temperature of the battery cell 650 exceeds the first threshold temperature and it is identified that the temperature of the battery cell 650 exceeds only the second threshold temperature, the processor may determine that there is an abnormality in the result identified in relation to the temperature of the corresponding battery cell 650.

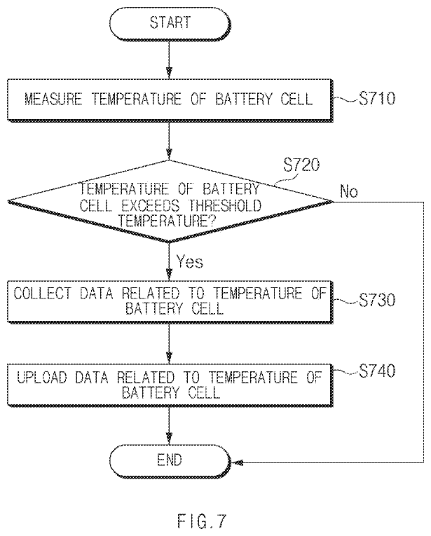

FIG. 7 is a flowchart illustrating a method of measuring a battery cell temperature according to an embodiment of the present disclosure.

According to an embodiment, in S710, the temperature of the battery cell may be measured through a temperature sensor. In this case, the temperature sensor may include a temperature switch whose resistance value changes based on identifying whether the temperature of the individual battery cell exceeds a threshold temperature, or a temperature switch whose switch circuit is converted to a shorted state or an open state.

According to an embodiment, in S720, the temperature sensor may identify whether the temperature of the battery cell exceeds the threshold temperature. For example, the temperature sensor may identify whether the temperature of the battery cell exceeds the first threshold temperature at which the durability of the battery cell is reduced. As another example, the temperature sensor may identify whether the temperature of the battery cell exceeds the second threshold temperature at which there is a risk of fire or explosion in the battery cell before fire or explosion due to thermal runaway occurs.

According to an embodiment, when the temperature of the battery cell does not exceed the threshold temperature in S720 (No), it may be determined that there is no heat in the battery cell, and the process may be terminated without collecting data related to the temperature of the battery cell.

According to an embodiment, when the temperature of the battery cell exceeds the threshold temperature in S720 (Yes), the processor may collect data related to the temperature of the battery cell in S730. In this case, the data related to the temperature of the battery cell may include at least one of a time for which the temperature of the battery cell is maintained above the threshold temperature, the number of times the temperature of the battery cell exceeds the threshold temperature, the durability of the battery cell, the durability of the battery management system including the plurality of battery cells, or a time for which the temperature of the battery cell is maintained at a temperature that does not exceed the threshold temperature after exceeding the threshold temperature, or a combination thereof.

According to an embodiment, in S740, the processor may upload the data related to the temperatures of the battery cell to at least one of a battery management system, or a server, or a combination thereof, or store the data related to the temperatures of all or some of the plurality of battery cells in the memory.

For example, the processor may upload time-related data among the data related to the temperatures of the battery cell as data in units of second to at least one of a battery management system, or a server, or a combination thereof, or store the time-related data in the memory.

As still another example, the processor may convert the time-related data among the data related to the temperatures of the battery cell into data in units of minute and upload the time-related data to at least one of a management system, or a server, or a combination thereof, or store the time-related data in the memory.

According to an embodiment, operations S710 to S740 may be repeated at a regular cycle. For example, even after the temperature of the battery cell exceeds the threshold temperature and data related to the temperature of the battery cell is uploaded, the temperature of the battery cell may be continuously measured. In addition, even when the temperature of the battery cell does not exceed the threshold temperature, the temperature of the battery cell may be continuously measured.

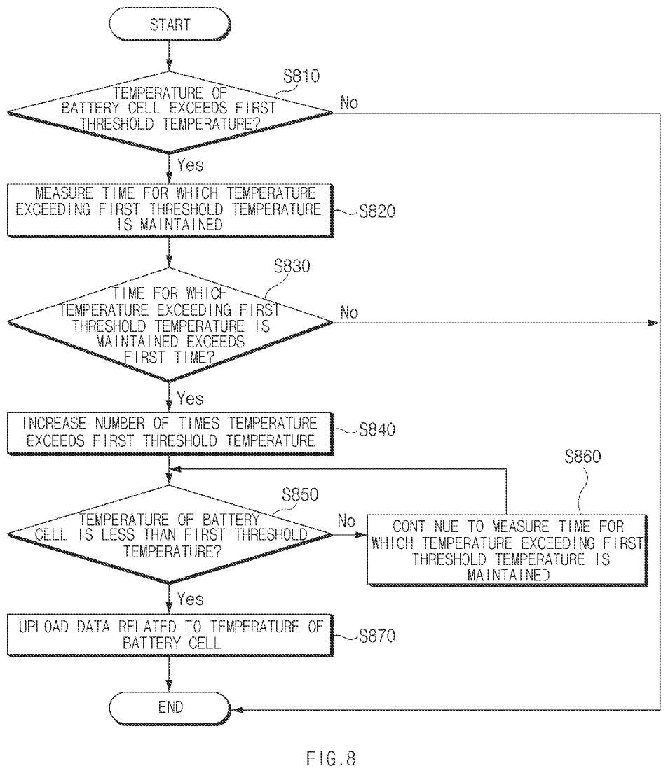

FIG. 8 is a flowchart illustrating a method of uploading data related to the temperature of a battery cell based on whether the temperature of the battery cell exceeds the first threshold temperature in a method of measuring a battery cell temperature according to an embodiment of the present disclosure.

According to an embodiment, in S810, the temperature sensor may identify whether the temperature of the battery cell exceeds the first threshold temperature. For example, the temperature sensor may identify whether the temperature of the battery cell exceeds the first threshold temperature at which the durability of the battery cell is reduced.

According to an embodiment, when the temperature of the battery cell exceeds the first threshold temperature in S810 (Yes), the processor may measure the time for which the temperature of the battery cell is maintained at a temperature exceeding the first threshold temperature in S820. In this case, the processor may measure the time in units of second for which the temperature exceeding the first threshold temperature of the battery cell is maintained.

According to an embodiment, in S830, the processor may determine whether the time for which the temperature of the battery cell is maintained at a temperature exceeding the first threshold temperature exceeds the first time. In this case, the first time may be set based on the threshold temperature. For example, in the case of the first threshold temperature at which the durability of the battery cell is reduced, the first time may be set to 1 second.

According to an embodiment, when the time for which the temperature of the battery cell is maintained at a temperature exceeding the first threshold temperature does not exceed the first time, the processor may determine that there is no abnormality in the battery cell with respect to the temperature, so that the process may be terminated in S830 (No).

According to an embodiment, when the time for which the temperature of the battery cell is maintained at a temperature exceeding the first threshold temperature exceeds the first time, in S840, the processor may increase the number of times the temperature of the battery cell exceeds the first threshold temperature.

For example, the processor may increase the number of times the temperature of the battery cell exceeds the first threshold temperature whenever the temperature of the battery cell exceeds from a temperature lower than the first threshold temperature to a temperature higher than the first threshold temperature. As a specific example, the processor may not increase the number of times the battery cell exceeds the first threshold temperature while the battery cell temperature remains above the first threshold temperature.

According to an embodiment, after the temperature of the battery cell exceeds the first threshold temperature, in S850, the processor may determine whether the temperature of the battery cell decreases below the first threshold temperature.

According to an embodiment, when the temperature of the battery cell remains above the first threshold temperature, in S860, the processor may continue to measure the time for which the temperature of the battery cell is maintained at a temperature exceeding the first threshold temperature. In this case, the measured time may be collected as the data related to the temperature of the battery cell. In addition, in S850, the processor may continuously determine whether the temperature of the battery cell has decreased below the first threshold temperature.

According to an embodiment, the processor may collect data related to the temperature of the battery cell when the temperature of the battery cell decreases below the first threshold temperature. In this case, the data related to the temperature of the battery cell may include a time for which the temperature of the battery cell is maintained above the first threshold temperature, the number of times the temperature of the battery cell exceeds the first threshold temperature, the durability of the battery cell, the durability of the battery management system including the plurality of battery cells, a time for which the temperature of the battery cell is maintained at a temperature that does not exceed the first threshold temperature after exceeding the first threshold temperature, and the like.

According to an embodiment, in S870, the processor may upload the data related to the temperatures of the battery cell to a battery management system, a server, or like, or store the data related to the temperatures of the battery cell in the memory.

For example, the processor may convert the time-related data among the data related to the temperatures of the battery cell into data in units of minute and upload the time-related data to a battery management system or a server, or store the time-related data in the memory.

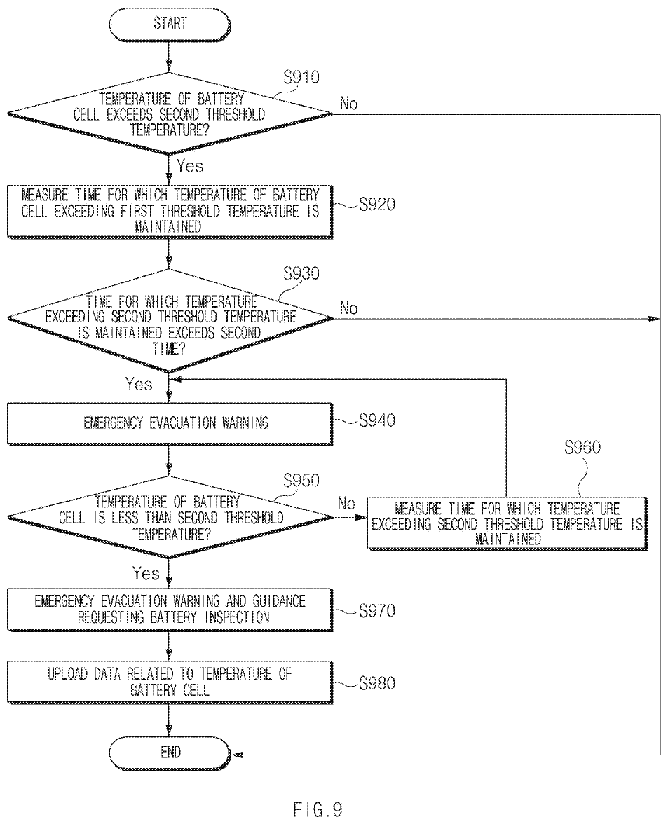

FIG. 9 is a flowchart illustrating a method of uploading data related to the temperature of a battery cell based on whether the temperature of the battery cell exceeds the second threshold temperature in a method of measuring a battery cell temperature according to an embodiment of the present disclosure.

According to an embodiment, in S910, the temperature sensor may identify whether the temperature of the battery cell exceeds the second threshold temperature. For example, the temperature sensor may identify whether the temperature of the battery cell exceeds the second threshold temperature at which there is a risk of fire in the battery cell before fire or explosion due to thermal runaway occurs.

According to an embodiment, when the temperature of the battery cell exceeds the second threshold temperature in S910 (Yes), the processor may measure the time for which the temperature of the battery cell is maintained at a temperature exceeding the second threshold temperature in S920. In this case, the processor may measure the time in units of second for which the temperature exceeding the second threshold temperature of the battery cell is maintained.

According to an embodiment, in S930, the processor may determine whether the time for which the temperature of the battery cell is maintained at a temperature exceeding the second threshold temperature exceeds the second time. In this case, the second time may be set based on the threshold temperature. For example, in the case of the second threshold temperature at which there is a risk of fire in the battery cell, the second time may be set to 10 seconds.

According to an embodiment, when the time for which the temperature of the battery cell is maintained at a temperature exceeding the second threshold temperature does not exceed the second time, the processor may determine that there is no abnormality in the battery cell with respect to the temperature, so that the process may be terminated in S930 (No).

According to an embodiment, when the time for which the temperature of the battery cell is maintained at a temperature exceeding the second threshold temperature exceeds the second time, in S940, the processor may provide an emergency evacuation warning to the user.

For example, the processor may provide the warning for emergency evacuation to the user through at least one of an in-vehicle display, in-vehicle audio, or a user terminal, or a combination thereof.

According to an embodiment, after the temperature of the battery cell exceeds the second threshold temperature, in S950, the processor may determine whether the temperature of the battery cell decreases below the second threshold temperature.

According to an embodiment, when the temperature of the battery cell remains above the second threshold temperature, in S960, the processor may continue to measure the time for which the temperature of the battery cell is maintained at a temperature exceeding the second threshold temperature. In this case, the measured time may be collected as the data related to the temperature of the battery cell. In addition, because the battery cell still remains at a temperature that poses a risk of explosion, in S940, the processor may continuously provide an emergency evacuation warning to the user.

According to an embodiment, when the temperature of the battery cell decreases below the second threshold temperature, in S970, the processor may provide an emergency evacuation warning and guidance requesting battery inspection. For example, in light of the temperature of the battery cell exceeding the second threshold temperature, there is still a risk of fire occurring in the battery cell, so even when the temperature of the battery cell decreases below the second threshold temperature, an emergency evacuation warning may be provided to the user.

According to an embodiment, the processor may collect data related to the temperature of the battery cell. In this case, the data related to the temperature of the battery cell may include a time for which the temperature of the battery cell is maintained above the second threshold temperature, the number of times the temperature of the battery cell exceeds the second threshold temperature, the durability of the battery cell, the durability of the battery management system including the plurality of battery cells, a time for which the temperature of the battery cell is maintained at a temperature that does not exceed the second threshold temperature after exceeding the second threshold temperature, and the like.

According to an embodiment, in S980, the processor may upload the data related to the temperatures of the battery cell to a battery management system, a server, or like, or store the data related to the temperatures of the battery cell in the memory.

For example, the processor may convert the time-related data among the data related to the temperatures of the battery cell into data in units of minute and upload the time-related data to a battery management system or a server, or store the time-related data in the memory.

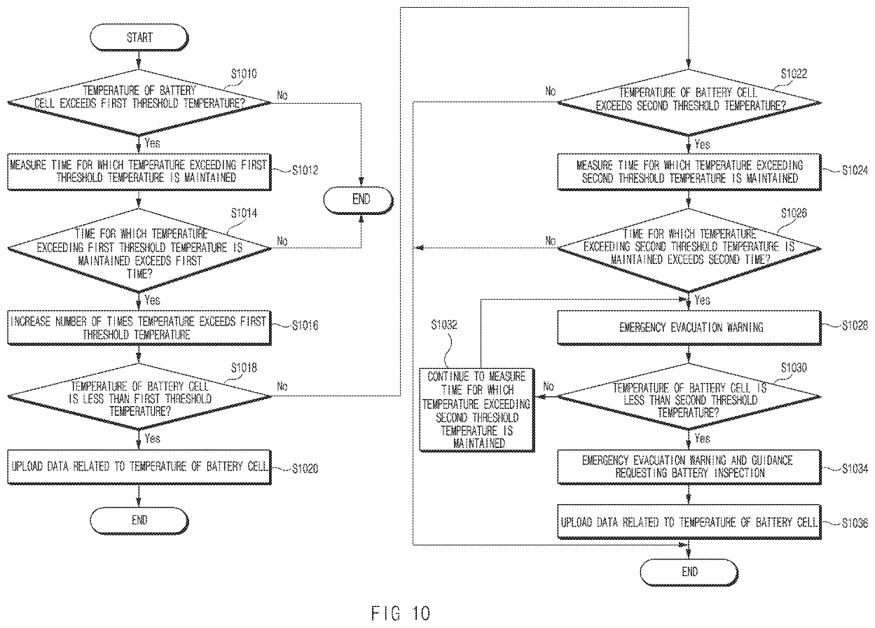

FIG. 10 is a flowchart illustrating a method of uploading data related to the temperature of a battery cell based on whether the temperature of the battery cell exceeds the first threshold temperature and the second threshold temperature in a method of measuring a battery cell temperature according to an embodiment of the present disclosure.

According to an embodiment in FIG. 10, both the first temperature sensor and the second temperature sensor may correspond to one battery cell.

According to an embodiment, in S1010, the first temperature sensor may identify whether the temperature of the battery cell exceeds the first threshold temperature. For example, the first temperature sensor may identify whether the temperature of the battery cell exceeds the first threshold temperature at which durability of the battery cell is reduced.

According to an embodiment, when the temperature of the battery cell exceeds the first threshold temperature in S1010 (Yes), the processor may measure the time for which the temperature of the battery cell is maintained at a temperature exceeding the first threshold temperature in S1020. In this case, the processor may measure the time in units of second for which the temperature exceeding the first threshold temperature of the battery cell is maintained.

According to an embodiment, in S1014, the processor may determine whether the time for which the temperature of the battery cell is maintained at a temperature exceeding the first threshold temperature exceeds the first time. In this case, the first time may be set based on the threshold temperature. For example, in the case of the first threshold temperature at which the durability of the battery cell is reduced, the first time may be set to 1 second.

According to an embodiment, when the time for which the temperature of the battery cell is maintained at a temperature exceeding the first threshold temperature does not exceed the first time, the processor may determine that there is no abnormality in the battery cell with respect to the temperature, so that the process may be terminated in S1014 (No).

According to an embodiment, when the time for which the temperature of the battery cell is maintained at a temperature exceeding the first threshold temperature exceeds the first time, in S1014 (Yes), the processor may increase the number of times the temperature of the battery cell exceeds the first threshold temperature in S1016.

For example, the processor may increase the number of times the temperature of the battery cell exceeds the first threshold temperature whenever the temperature of the battery cell exceeds from a temperature lower than the first threshold temperature to a temperature higher than the first threshold temperature. As a specific example, the processor may not increase the number of times the battery cell exceeds the first threshold temperature while the battery cell temperature remains above the first threshold temperature.

According to an embodiment, after the temperature of the battery cell exceeds the first threshold temperature, in S1018, the processor may determine whether the temperature of the battery cell decreases below the first threshold temperature.

According to an embodiment, in S1018, the processor may collect data related to the temperature of the battery cell when the temperature of the battery cell decreases below the first threshold temperature (Yes). In this case, the data related to the temperature of the battery cell may include a time for which the temperature of the battery cell is maintained above the first threshold temperature, the number of times the temperature of the battery cell exceeds the first threshold temperature, the durability of the battery cell, the durability of the battery management system including the plurality of battery cells, a time for which the temperature of the battery cell is maintained at a temperature that does not exceed the first threshold temperature after exceeding the first threshold temperature, and the like.

According to an embodiment, when the temperature of the battery cell decreases below the first threshold temperature in S1018 (Yes), in S1020, the processor may upload the data related to the temperatures of the battery cell to a battery management system, a server, or like, or store the data related to the temperatures of the battery cell in the memory

For example, the processor may convert the time-related data among the data related to the temperatures of the battery cell into data in units of minute and upload the time-related data to a battery management system or a server, or store the time-related data in the memory.

According to an embodiment, when the temperature of the battery cell remains above the first threshold temperature, in S1018 (No), the processor may identify whether the temperature of the battery cell exceeds the second threshold temperature through the second temperature sensor in S1022. For example, the second temperature sensor may identify whether the temperature of the battery cell exceeds the second threshold temperature at which there is a risk of fire in the battery cell before fire or explosion due to thermal runaway occurs.

According to an embodiment, when the temperature of the battery cell exceeds the second threshold temperature in S1022 (Yes), the processor may measure the time for which the temperature of the battery cell is maintained at a temperature exceeding the second threshold temperature in S1024. In this case, the processor may measure the time in units of second for which the temperature exceeding the second threshold temperature of the battery cell is maintained.

According to one embodiment, in S1026, the processor may determine whether the time for which the temperature of the battery cell is maintained at a temperature exceeding the second threshold temperature exceeds the second time. In this case, the second time may be set based on the threshold temperature. For example, in the case of the second threshold temperature at which there is a risk of fire in the battery cell, the second time may be set to 10 seconds.

According to an embodiment, when the time for which the temperature of the battery cell is maintained at a temperature exceeding the second threshold temperature does not exceed the second time, the processor may determine that there is no abnormality in the battery cell with respect to the temperature, so that the process may be terminated in S1026 (No).

According to an embodiment, when the time for which the temperature of the battery cell is maintained at a temperature exceeding the second threshold temperature exceeds the second time, in S1028, the processor may provide an emergency evacuation warning to the user.

For example, the processor may provide the warning for emergency evacuation to the user through at least one of an in-vehicle display, in-vehicle audio, or a user terminal, or a combination thereof.

According to an embodiment, after the temperature of the battery cell exceeds the second threshold temperature, in S1030, the processor may determine whether the temperature of the battery cell decreases below the second threshold temperature.

According to an embodiment, when the temperature of the battery cell remains above the second threshold temperature in S1030 (No), the processor may continue to measure the time for which the temperature of the battery cell is maintained at a temperature exceeding the second threshold temperature in S1032. In this case, the measured time may be collected as the data related to the temperature of the battery cell. In addition, because the battery cell still remains at a temperature that poses a risk of explosion, in S1028, the processor may continuously provide an emergency evacuation warning to the user.

According to an embodiment, when the temperature of the battery cell decreases below the second threshold temperature, in S1034, the processor may provide an emergency evacuation warning and guidance requesting battery inspection. For example, in light of the temperature of the battery cell exceeding the second threshold temperature, there is still a risk of fire occurring in the battery cell, so even when the temperature of the battery cell decreases below the second threshold temperature, an emergency evacuation warning may be provided to the user.

According to an embodiment, the processor may collect data related to the temperature of the battery cell. In this case, the data related to the temperature of the battery cell may include a time for which the temperature of the battery cell is maintained above the second threshold temperature, the number of times the temperature of the battery cell exceeds the second threshold temperature, the durability of the battery cell, the durability of the battery management system including the plurality of battery cells, a time for which the temperature of the battery cell is maintained at a temperature that does not exceed the second threshold temperature after exceeding the second threshold temperature, and the like.

According to an embodiment, in S1036, the processor may upload the data related to the temperatures of the battery cell to a battery management system, a server, or like, or store the data related to the temperatures of the battery cell in the memory.

For example, the processor may convert the time-related data among the data related to the temperatures of the battery cell into data in units of minute and upload the time-related data to a battery management system or a server, or store the time-related data in the memory.

According to an embodiment, when it is not identified that the temperature of the battery cell exceeds the first threshold temperature and it is identified that the temperature of the battery cell exceeds only the second threshold temperature, the processor may determine that the data related to the temperature of the battery cell is abnormal. In this case, the data related to the temperature of the battery cell may be collected again.

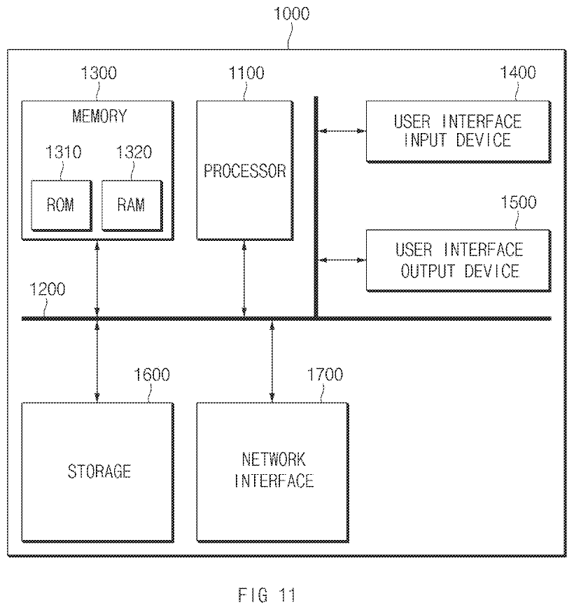

FIG. 11 is a block diagram illustrating a computing system related to an apparatus for measuring a battery cell temperature and a method of measuring a battery cell temperature according to an embodiment of the present disclosure.

Referring to FIG. 11, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The present technology may minimize blind spots where the temperature of a battery cell may not be measured.

In addition, the present technology may measure the temperatures of many battery cells with only a minimum number of channels because a plurality of temperature sensors are connected to a processor through one channel.

In addition, the present technology may reduce component costs by measuring the temperatures of many battery cells through a minimum number of channels.

In addition, the present technology may quickly detect abnormality in a battery cell by diagnosing the battery cell based on whether the temperature of the battery cell exceeds the threshold temperature.

In addition, the present technology may secure evacuation time for a user by quickly detecting abnormality in a battery cell.

In addition, the present technology may increase the convenience of collecting data related to the temperatures of battery cells by using software.

In addition, various effects that are directly or indirectly understood through the present disclosure may be provided.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

1. An apparatus for measuring a battery cell temperature, the apparatus comprising:
a memory configured to store a program instruction;
a processor configured to execute the program instruction; and
a plurality of first temperature sensors configured to detect whether temperatures of all or some of a plurality of battery cells exceed a threshold temperature;
wherein each of the plurality of first temperature sensors corresponds to an individual battery cell included in all or some of the plurality of battery cells in an N:1 relationship, wherein N is a natural number greater than or equal to 1 and represents a number of first temperature sensors, and 1 represents a number of individual batteries; and
wherein the processor is configured to collect data related to the temperatures of all or some of the plurality of battery cells based on detecting whether a temperature of the individual battery cell exceeds the threshold temperature through at least one of the plurality of first temperature sensors.

2. The apparatus of claim 1, wherein the processor is configured to detect whether the temperature of the individual battery cell exceeds the threshold temperature through one channel to which the plurality of first temperature sensors are connected.

3. The apparatus of claim 1, wherein the first temperature sensor includes a temperature switch having a resistance value that changes based on identifying whether the temperature of the individual battery cell exceeds the threshold temperature.

4. The apparatus of claim 1, wherein the threshold temperature includes a first threshold temperature at which durability of the individual battery cell is reduced.

5. The apparatus of claim 1, wherein the data related to the temperatures includes at least one of a time for which the temperature of the individual battery cell is maintained above the threshold temperature, a number of times the temperature of the individual battery cell exceeds the threshold temperature, durability of the individual battery cell, durability of a battery management system including the plurality of battery cells, or a time for which the temperature of the individual battery cell is maintained at a temperature that does not exceed the threshold temperature after exceeding the threshold temperature, or a combination thereof.

6. The apparatus of claim 1, wherein the processor is configured to upload the data related to the temperatures of all or some of the plurality of battery cells to at least one of a battery management system, or a server, or a combination thereof, or configured to store the data related to the temperatures of all or some of the plurality of battery cells in the memory, based on identifying that the temperature of the individual battery cell exceeds the threshold temperature.

7. The apparatus of claim 1, wherein the threshold temperature includes a second threshold temperature at which a risk of fire occurs in the individual battery cell before fire or explosion occurs due to thermal runaway; and
wherein the processor is configured to provide a warning to a user for emergency evacuation based on identifying that the temperature of the individual battery cell exceeds the second threshold temperature.

8. The apparatus of claim 1, further comprising:
a plurality of second temperature sensors;
wherein each of the plurality of first temperature sensors is configured to detect whether the temperature of the individual battery cell exceeds a first threshold temperature at which durability of the individual battery cell is reduced;
each of the plurality of second temperature sensors is configured to detect whether the temperature of the individual battery cell exceeds a second threshold temperature at which a risk of fire occurs in the individual battery cell before fire or explosion occurs due to thermal runaway; and
the processor is configured to collect the data related to the temperatures of all or some of the plurality of battery cells based on detecting that the temperature of the individual battery cell exceeds the first threshold temperature, the second threshold temperature or a combination thereof through at least one first temperature sensor among the plurality of first temperature sensors and at least one second temperature sensor among the plurality of second temperature sensors.

9. The apparatus of claim 8, wherein the processor is configured to determine that the data related to the temperatures of all or some of the plurality of battery cells is abnormal, based on identifying that the temperature of the individual battery cell does not exceed the first threshold temperature and the temperature of the individual battery cell exceeds the second threshold temperature.

10. The apparatus of claim 8, further comprising:
a plurality of third temperature sensors;
wherein each of the plurality of third temperature sensors is configured to detect whether the temperature of the individual battery cell exceeds a third threshold temperature between the first threshold temperature and the second threshold temperature; and
wherein the processor is configured to provide a warning for emergency evacuation to a user by reflecting changes in the temperature of the individual battery cells based on identifying that the temperature of the individual battery cell exceeds the second threshold temperature through each of the plurality of second temperature sensors after the temperature of the individual battery cell exceeds the first threshold temperature through each of the plurality of first temperature sensors, and the temperature of the individual battery cell exceeds the third threshold temperature through each of the plurality of third temperature sensors.

11. A method of measuring a battery cell temperature, the method comprising:
detecting, by at least one of a plurality of first temperature sensors, whether a temperature of an individual battery cell included in all or some of a plurality of battery cells exceed a threshold temperature; and
collecting, by a processor, data related to the temperatures of all or some of the plurality of battery cells based on detecting whether the temperature of the individual battery cell exceeds the threshold temperature through at least one of the plurality of first temperature sensors.

12. The method of claim 11, wherein collecting the data includes detecting, by the processor, whether the temperature of the individual battery cell exceeds the threshold temperature through one channel to which the plurality of first temperature sensors are connected.

13. The method of claim 11, wherein each of the plurality of first temperature sensors includes a temperature switch having a resistance value that changes based on identifying whether the temperature of the individual battery cell exceeds the threshold temperature.

14. The method of claim 11, wherein the threshold temperature includes a first threshold temperature at which durability of the individual battery cell is reduced.

15. The method of claim 11, wherein the data related to the temperatures includes at least one of a time for which the temperature of the individual battery cell is maintained above the threshold temperature, a number of times the temperature of the individual battery cell exceeds the threshold temperature, durability of the individual battery cell, durability of a battery management system including the plurality of battery cells, or a time for which the temperature of the individual battery cell is maintained at a temperature that does not exceed the threshold temperature after exceeding the threshold temperature, or a combination thereof.

16. The method of claim 11, further comprising:
uploading, by the processor, the data related to the temperatures of all or some of the plurality of battery cells to at least one of a battery management system, or a server, or a combination thereof, or storing the data related to the temperatures of all or some of the plurality of battery cells in the memory, based on identifying that the temperature of the individual battery cell exceeds the threshold temperature.

17. The method of claim 11, wherein the threshold temperature includes a second threshold temperature at which a risk of fire occurs in the individual battery cell before fire or explosion occurs due to thermal runaway; and
the method further includes providing, by the processor, a warning to a user for emergency evacuation based on identifying that the temperature of the individual battery cell exceeds the second threshold temperature.

18. The method of claim 11, wherein detecting whether the temperature of the individual battery cell exceeds the threshold temperature includes:
detecting, by each of the plurality of first temperature sensors, whether the temperature of the individual battery cell exceeds a first threshold temperature at which durability of the individual battery cell is reduced; and
detecting, by a second temperature sensor among a plurality of second temperature sensors, whether the temperature of the individual battery cell exceeds a second threshold temperature at which a risk of fire occurs in the individual battery cell before fire or explosion occurs due to thermal runaway; and
wherein collecting the data includes collecting, by the processor, the data related to the temperatures of all or some of the plurality of battery cells based on detecting that the temperature of the individual battery cell exceeds the first threshold temperature, the second threshold temperature or a combination thereof through at least one first temperature sensor among the plurality of first temperature sensors, and at least one second temperature sensor among the plurality of second temperature sensors.

19. The method of claim 18, wherein collecting the data includes determining, by the processor, that the data related to the temperatures of all or some of the plurality of battery cells is abnormal based on identifying that the temperature of the individual battery cell does not exceed the first threshold temperature and the temperature of the individual battery cell exceeds the second threshold temperature.

20. The method of claim 18, wherein detecting whether the temperature of the individual battery cell exceeds the threshold temperature includes detecting, by a third temperature sensor, whether the temperature of the individual battery cell exceeds a third threshold temperature between the first threshold temperature and the second threshold temperature; and
wherein the method further includes providing, by the processor, a warning for emergency evacuation to a user by reflecting changes in the temperature of the individual battery cells based on identifying that the temperature of the individual battery cell exceeds the second threshold temperature through each of the plurality of second temperature sensors after the temperature of the individual battery cell exceeds the first threshold temperature through each of the plurality of first temperature sensors and the temperature of the individual battery cell exceeds the third threshold temperature through the third temperature sensor.
